(19) United States
(12) Patent Application Publication
(10) Pub. No.: US 2010/0101095 A1
(43) Pub. Date: Apr. 29, 2010

(54) TACTICAL KNIFE

(76) Inventor: Daniel Prasetya, Fort Collins, CO (US)

Correspondence Address: THE MCCALLUM LAW FIRM, P. C., 685 BRIGGS STREET, PO BOX 929, ERIE, CO, 80516, US

(21) Appl. No.: 12/450,238

(22) PCT Filed: Mar. 17, 2008
(86) PCT No.: PCT/US08/03530

§ 371 Date: Sep. 16, 2009

Related U.S. Application Data
(60) Provisional application No. 60/918,592, filed on Mar. 16, 2007.

(51) Int. Cl. B26B 11/00; B26B 3/00; B26B 9/00

(52) U.S. Cl. 30/123; 30/294; 30/355

(57) ABSTRACT

Certain embodiments of the present invention provide a tactical knife. The knife, in certain embodiments, includes a handle and a blade. The blade may further be formed so as to include a sharp edge, a sharp serrated edge, a non-sharp serrated edge and a gut hook. In certain embodiments, the handle may house a light source so the knife may be used in poorly lit environments and/or in combination with a gun. A power source may be housed inside of the handle and the handle may also include a dome switch to operate the light source. Sufficient sealant is placed in strategic locations throughout the handle so as to make the knife of certain embodiments of the present invention water resistant.

### FIELD OF THE INVENTION

The present invention relates generally to knives, and more particularly, to a tactical knife including a sharp edge, a sharp serrated edge, a non-sharp serrated edge, a gut hook and optionally a light source.

### BACKGROUND OF THE INVENTION

The use of the knife as a tool is as old as human history. Primitive tribes used knives for everyday survival—as tools of attack, defense, hunting, and domestic utility. Today knives remain a primary tool with uses including cooking, surgery, combat, and even as letter openers. Over time, knives have evolved in style and function and their core components, a handle and a blade, have somewhat further evolved to meet the needs of particular uses.

The earliest users of the knife were hunters and cooks. Hunters used knives not only for killing their prey, but also for defending themselves from the animals they intended to kill. From this essential need the self-defense arts were born, not only for defense from animals but also from other humans. One example of a form of martial arts that employs knife-handling skills that grew out of the culinary arts is Pencak Silat. Inti Ombak, which translates from Indonesian into, “Inner Wave,” is one of the schools that still emphasizes this knife training from the very first class.

In the modern world, people oftentimes think of the gun as the weapon of choice. Realistically, though, the knife will outperform the gun in many situations. Knives have great versatility, and can be used to handle attacks from all directions, unlike the gun, which can only be used for a straight, frontal attack. Furthermore, the fact that carrying a gun is not legal in many countries throughout the world highlights another advantage of the knife, since they are generally readily available and it is permissible to carry them in many places a gun is not allowed.

Knives known in the art are not typically adaptable to the various knife handling techniques. Also, prior knives generally do not offer sufficient leverage when a user is engaging in different forms or postures known in the martial arts. Moreover, prior knives do not incorporate the myriad of potential uses that a knife may be capable of having alongside a defensive purpose. These uses may include particular blade designs to enable the user to easily cut a parachute cord and further be capable of deflecting a knife of an opponent, specific blade lengths so as to allow leverage to the user and also being long enough to puncture a heart, spinal cord, or other vital organs, and specific features on the blade to allow the knife to be useful in survival techniques such as striking and sparking a flint so as to create fire and in preparing food for cooking. Further, knives incorporating lights are known in the prior art but the placement of the light on the prior knives do not allow the light to be used to its maximum efficiency when using the knife in or poorly lit environment or in combination with a gun. As such, there exists a need for a knife to meet the aforementioned needs and which may be compatible with some, or all, of the knife handling techniques used in self-defense.

### SUMMARY OF THE INVENTION

It is therefore an object of the present invention to provide a new and improved tactical knife which overcomes all of the aforementioned disadvantages.

It is another object of the present invention to provide a new and improved tactical knife which may incorporate a strategically placed light source in certain embodiments.

It is a further object of the present invention to provide a new and improved tactical knife which may be used in accordance with the various knife handling techniques of a martial arts practitioner. In a particular embodiment, the martial arts practitioner is a Pencak Silat Inti Ombak practitioner.

Other objects of certain embodiments of the present invention relate to a tactical knife having a handle, a power source and a light source housed inside of the handle. Located on the handle is a dome switch wherein activating the dome switch operates or turns on and off the light source. The tactical knife has a blade that incorporates a sharp edge, a sharp serrated edge, a non-sharp serrated edge, and a gut hook; all particularly placed along the body of the blade so as to afford the user of the maximum advantages of the tactical knife.

Certain advantages associated with particular embodiments of the present invention include, but are not limited to, the capability of striking and sparking a flint, the capability of preparing food for cooking, cutting a parachute cord, piercing vital organs such as the heart, piercing the spinal cord, deflecting another knife of an opponent or other defensive uses, providing maximum leverage to its user, providing a particularly placed lighting source so the knife may be used to its maximum capabilities in a dark environment or in combination with a gun, and affording its user sufficient leverage when the user is engaging in different forms, postures or knife handling techniques known in the martial arts.

An even further object of the present invention is to provide a new and improved tactical knife which is susceptible to a low cost of manufacture with regard to both materials and labor, including its embodiment incorporating a light source, and which accordingly is then available for an economical price.

Another object of certain embodiments of the present invention is to provide a new and improved combined tactical knife and light source wherein the light may be switched on and off by a convenient press of a dome switch located on the handle of the knife.

Yet another object of the present invention is to provide a new and improved tactical knife which is characterized by a durable, lightweight, rugged and waterproof construction.

These together with other objects and advantages of the present invention, along with the various features of novelty which characterize the invention, are pointed out with particularity in the claims annexed to and forming a part of this disclosure. The invention is capable of other embodiments and of being practiced or being carried out in various ways. Further objectives of the present invention will become apparent from a consideration of the drawings and ensuing description. As such, for a better understanding of the present invention, its operating advantages and the specific objects attained by its uses, reference should be made to the accompanying drawings and detailed description illustrating some of the preferred embodiments of the present invention.

### BRIEF DESCRIPTION OF THE DRAWINGS

FIG. 1 is a perspective view of the tactical knife not including a light source according to certain embodiments of the present invention.

FIG. 2 is a cross-sectional view of the tactical knife incorporating a light source and showing its operational components according to certain embodiments of the present invention.

### DETAILED DESCRIPTION OF THE INVENTION

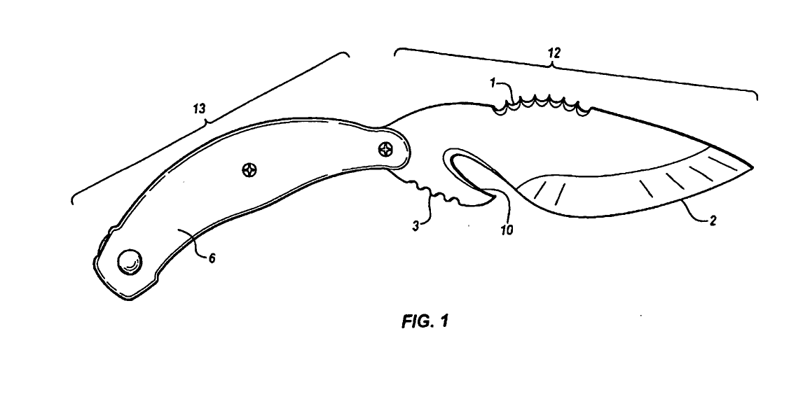

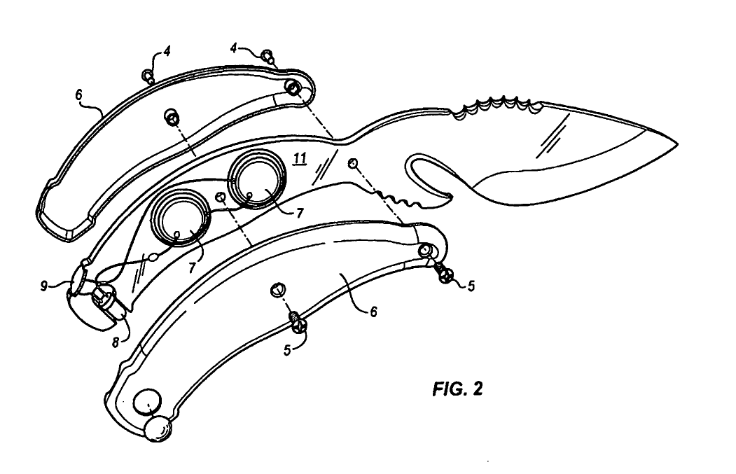

FIGS. 1 and 2 show certain embodiments of the present invention that include a blade 12 and a handle 13. The handle may include handle covers 6 having a substantially symmetrical profile to receive between them a light source 8, a power source 7, a dome switch 9 and a handle insert portion 11. The handle covers 6 may be made of any material known in the art of handle materials including, but not limited to, any metal, carbon steel, stainless steel, ceramics, marble, wood, and plastics. The handle covers 6 are fastened to each other, with the handle insert portion 11 being between them. The covers 6 may be fastened to each other via any method known in the art including, but not limited to, male 5 and female 4 screws. In a particular embodiment, there are holes punched through the handle covers 6 and the handle insert portion 11 so that the male 5 and female 4 screws may extend and fasten therethrough. Once fastened, the power source 7, which is located on the handle insert portion 11, is housed inside of the handle 13. The power source 7 may be any power source able to provide power to the light source 8. In one embodiment of the present invention, the handle 13 may be in the range of three (3) inches to five (5) inches in length. In a particular embodiment, the handle 13 is four and one quarter (4.25) inches in length. In another embodiment of the present invention, the handle 13 may be in the range of six (6) millimeters (hereinafter “mm”) to seven (7) mm in width. In a particular embodiment, the handle 13 is 6.5 mm in width.

The power source 7 may be any source capable of supplying power to the light source 8 including, but not limited to, a battery. Although FIG. 2 illustrates the power source 7 as two batteries, such power source may be more than two items and/or even just one power source. Further housed inside of the handle 13 is the light source 8 which is electronically connected to the power source 7. However, the handle 13 contains an opening wherein the light source 8, when illuminated, can direct a beam of light therethrough. In certain embodiments the light source 8 may be a light-emitting diode (LED). The light source 8 may emit any type or color of light and can be of the type that emits red or white light when electrical current is passed therethrough, such as a conventional LED. In a particular embodiment, a small amount of sealant is applied around the light source 8 flush with the surface of the handle covers 6 so as to make the knife of certain embodiments of the present invention water resistant. In order to turn the light on or off, e.g., operate the light, there is a dome switch 9 located on the handle insert portion 13 and protruding through the handle 13. The dome switch 9 is electronically connected to the power source 7 so that when the dome switch 9 is activated, e.g., pressed by a user, it electronically connects the light source 8 and the power source 7, thus completing an electrical circuit and causing-current to flow through the light source 8 thereby causing the light source 8 to emit a beam of light. In a particular embodiment, a small amount of sealant is applied around the dome switch 9 flush with the surface of the handle covers 6 so as to make the knife of certain embodiments of the present invention water resistant.

Once the handle insert portion 11 is housed in the handle 13 by the fastened handle covers 6, there remains a blade 12 extending from the handle and protruding out from the handle 13. The blade 12 including the handle insert portion 11 may be made of any material known in the art of knife blade materials including, but not limited to, any metal, carbon steel, stainless steel, ceramics, marble, wood, and plastics. The blade 12 protruding from the handle 13 may have any length. In one embodiment of the present invention, the blade 12 has a length in the range of three (3) inches to six (6) inches. In a particular embodiment, the blade 12 protruding from the handle has a length of three (3) inches measured from the base of the blade 12, e.g. where it meets the handle 13, to the pointed end of the blade 12. Further, the blade 12 has a varying thickness in the range of one (1) mm to eight (8) mm. The thickness of the blade 12 near the pointed end is about two (2) mm and the blade 12 generally becomes thicker as you move towards the handle 13. Near the portion where the blade 12 meets the handle 13, the blade 12 may have a thickness of about six and one half (6.5) mm.

As shown if FIGS. 1 and 2, the bottom portion of the blade 12 includes a non-sharp serrated edge 3, a gut hook 10, and a sharp edge 2. The non-sharp serrated edge 3 may be in the range of one (1) to one and one half (1.5) inches in length. In a particular embodiment, the non-sharp serrated edge is about one and one quarter (1.25) inches in length, and in the range of six (6) mm to seven (7) mm in width or about six and one half (6.5) mm in width. The non-sharp serrated edge 3 generally extends from where the blade 12 meets the handle 13 out about one and one quarter (1.25) inches to a point where a gut hook 10 is formed in the blade 12. The gut hook 10 is generally an inlet formed in the blade 12 wherein the inlet has an opening in the range of about one quarter (0.25) inches to about one (1) inch. In a particular embodiment, the inlet forming the gut hook 10 has an opening of about one half (0.5) inches. In a particular embodiment, the gut hook 10 may be used to open a bottle.

Moving further along the bottom portion of the blade 12 after the gut hook 10, there is a sharp edge 2. This sharp edge 2 is generally in the range of two and one half (2.5) inches to three and one half (3.5) inches in length. In a particular embodiment, the sharp edge 2 is about three (3) inches in length. It extends from the gut hook 10 along the bottom portion of the blade 12 up to the point of the blade 12. The sharp edge 2 may optionally include a non-stick coating, such as Teflon™ to assist with the cutting and chopping of food so that the cut food will not stick to the blade.

The top portion of the blade 12 is generally not sharp except for a portion comprising a sharp serrated edge 1. This sharp serrated edge 1 may be in the range of one (1) inch to one and one half (1.5) inches in length. In a particular embodiment, the sharp serrated edge 1 is about one and one eighth (1.125) inches in length along the top portion of the blade 12. Also, the sharp serrated edge 1 may be located anywhere along the top portion of the blade 12. In a particular embodiment, the sharp serrated edge 1 is located beginning about one and one quarter (1.25) inches from the handle 13 and extending some one and one eighth (1.125) inches towards the point of the blade 12.

Among the aforementioned aspects of the present invention, FIG. 1 also portrays an alternate embodiment of the present invention wherein said tactical knife does not include a power source 7, a light source 8, or a dome switch 9 (all shown in FIG. 2).

For the purposes of the present invention, the term “a” or “an” entity refers to one or more than one of that entity; for example, “a handle” or “an edge” refers to one or more of those elements, or at least one element. As such, the terms “a” or “an”, “one or more” and “at least one” can be used interchangeably herein. It is also to be noted that the terms “comprising”, “including”, and “having” can be used interchangeably. Furthermore, a compound “selected from the group consisting of” refers to one or more of the compounds in the list that follows, including mixtures (i.e. combinations) of two or more of the compounds.

All of the METHODS and APPARATUS disclosed and claimed herein can be made and executed without undue experimentation in light of the present disclosure. While the compositions and methods of this invention have been described in terms of preferred embodiments, it will be apparent to those of skill in the art that variations may be applied to the METHODS and APPARATUS and in the steps or in the sequence of steps of the methods described herein without departing from the concept, spirit and scope of the invention. More specifically, it will be apparent that certain agents that are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

We claim:

1. A tactical knife comprising:
a) a handle;
b) a blade having a sharp edge, a sharp serrated edge, a non-sharp serrated edge, a gut hook and a handle insert portion, said handle insert portion being removably attached to said handle.

2. The tactical knife of claim 1, wherein said blade has a thickness in the range of 1 mm to 8 mm and a length in the range of 4 inches to 6 inches.

3. The tactical knife of claim 2, wherein said sharp edge is in the range of 2.5 mm to 3.5 mm in length.

4. The tactical knife of claim 3, wherein said handle has a thickness in the range of 6 mm to 7 mm and a length in the range of 4 inches to 5 inches.

5. The tactical knife of claim 4, wherein said sharp serrated edge and said non-sharp serrated edge are in the range of 1 inch to 1.5 inches in length.

6. The tactical knife of claim 5, wherein said handle insert portion further includes a power source.

7. The tactical knife of claim 6, further comprising a light source housed in said handle and electronically connected to said power source wherein said light source emits a light through an opening in said handle.

8. The tactical knife of claim 7, wherein said light source is a light-emitting diode.

9. The tactical knife of claim 8, further comprising a dome switch located on said handle wherein activating said dome switch electrically connects or disconnects said power source to said light source to operate said light.

10. A tactical knife comprising:
a) a handle;
b) a blade having a sharp edge, a sharp serrated edge, a non-sharp serrated edge, a gut hook and a handle insert portion including a power source, said handle insert portion being removably attached to said handle;
c) a light source housed in said handle and electronically connected to said power source wherein said light source emits a light through an opening in said handle; and
d) a dome switch located on said handle wherein activating said dome switch electrically connects or disconnects said power source to said light source to operate said light.

11. The tactical knife of claim 10, wherein said blade has a thickness in the range of 1 mm to 8 mm and a length in the range of 4 inches to 6 inches.

12. The tactical knife of claim 11, wherein said sharp edge is in the range of 2.5 mm to 3.5 mm in length.

13. The tactical knife of claim 12, wherein said handle has a thickness in the range of 6 mm to 7 mm and a length in the range of 4 inches to 5 inches.

14. The tactical knife of claim 13, wherein said sharp serrated edge and said non-sharp serrated edge are in the range of 1 inch to 1.5 inches in length.

15. The tactical knife of claim 14, wherein said light source is a light-emitting diode.

16. A tactical knife comprising:
a) a handle having a thickness in the range of 6 mm to 7 mm and a length in the range of 4 inches to 5 inches;
b) a blade having a thickness in the range of 1 mm to 8 mm and a length in the range of 4 inches to 6 inches;
c) said blade having a sharp edge with a length in the range of 2.5 mm to 3.5 mm;
d) a sharp serrated edge and a non-sharp serrated edge, said edges having lengths in the range of 1 inch to 1.5 inches;
e) a gut hook; and
f) a handle insert portion, said handle insert portion being removably attached to said handle.

17. The tactical knife of claim 16, wherein said handle insert portion further includes a power source.

18. The tactical knife of claim 17, further comprising a light source housed in said handle and electronically connected to said power source wherein said light source emits a beam of light through an opening in said handle.

19. The tactical knife of claim 18, wherein said light source is a light-emitting diode.

20. The tactical knife of claim 19, further comprising a dome switch located on said handle wherein activating said dome switch electrically connects or disconnects said power source to said light source to operate said light.
